(19) United States
(12) Patent Application Publication
(10) Pub. No.: US 2011/0208326 A1
(43) Pub. Date: Aug. 25, 2011

(54) STRUCTURAL SUPPORT AND TRACKING SYSTEM

(76) Inventor: Eyal Dror, Moshav Asseret (IL)

(21) Appl. No.: 13/057,101

(22) PCT Filed: Aug. 4, 2009
(86) PCT No.: PCT/IL09/00759

§ 371 Date: Feb. 1, 2011

(30) Foreign Application Priority Data
Aug. 4, 2008 (US) 61129980
Sep. 11, 2008 (US) 61/136513

(51) Int. Cl. G05B 13/00; F16M 11/18

(52) U.S. Cl. 700/71; 248/372.1

(57) ABSTRACT

A structural support and tracking system comprising a utility platform defining an X-Y plane and supported over a central support post defining a longitudinal axis Z being normal to the plane X-Y. The utility platform comprises at least three platform cord connection elements, at least three left ground cord connection elements associated with two left platform cord connection elements, and at least one right ground cord connection element associated with at least one right platform cord connection element (PCCE). A tension cord system wherein a cord extends from each platform cord connection element towards at least one corresponding ground cord connection elements, and a manipulating system for tilting the utility platform by tension adjustment of the cords.

### FIELD OF THE INVENTION

This invention relates to support system carrying a utility platform, wherein the platform is spatially manipulable. The support system is useful for example, as a tracking system or as a support structure for various construction purposes, etc.

### BACKGROUND OF THE INVENTION

Tracking systems for flat and concentrating panels are used to focus/direct solar energy and other forms of radiation onto a receiver which collects the radiation or signal for use. The tracker must keep the collecting surface pointing at the sun or energy source so that maximum energy will be absorbed by the receiver. For that purpose it is required that a tracking system be capable of accurate incremental angular displacement.

The prior art contains a number of examples of methods for azimuth and elevation tracking of energy concentrating antennas and solar collectors. Most conventional heliostat and dish trackers use pedestal mounted gear box drives to provide azimuth and elevation control. Wind loads on large area collectors place very large torques and moments on these gear boxes. Most of these devices simply resist wind and gravity loadings with increased structural weight.

An example of a prior art tracking system is disclosed in GB Patent Application 2114376 disclosing an antenna apparatus having a support device to be fixed to a given installing body, an antenna body e.g. a parabolic reflector having a given directivity, and a ball joint mechanically coupling the support device to the antenna body. Two different positions of the antenna body are coupled via a wire or rope so that the direction of the antenna body with respect to a given axis is changed by the push-pull movement of the rope. Similarly other pairs of positions connected by wires provide orientation about other axes. Once the apparatus has been installed and the direction adjusted, the wires are fixed so that the reflector cannot move. Details of fixings, pulleys, ball joints and clamps are disclosed. The arrangement is useful for domestic reception of Super High Frequency signals from a geostationary satellite.

Japan Patent Publication JP2004-64195 discloses a drive comprising a 1st circular slide rail that rotates to one shaft orientations, a 2nd circular slide rail that rotates to shaft orientations which have a slot into which said 1st slide rail fits, and are different from said 1st slide rail and a mount table with a slot into which said 2nd slide rail fits.

Other prior art systems relating to tracking systems are disclosed, for example, in U.S. Pat. Nos. 4,363,354, 4,608,964, 4,870,949 and 5,325,844.

### SUMMARY OF THE INVENTION

Hereinafter in the specification and claims, reference is made to several particular designs. However, it is by no means intended to restrict the system according to the present invention to an equatorially oriented system. Thus, the structure may be oriented otherwise, such as for example, azimuth/altitude, or the like, where a plane defined by a utility platform can be either parallel to the horizon or disposed at some other angle.

Herein after, the invention will be described without reference to a particular application, however without being limited to any. The term utility platform as used herein in the specification and claims denotes any such collector or other construction mounted directly or indirectly on a manipulable platform.

The terms front side and rear side as used herein in the specification and claims define location along the longitudinal, X-X axis, wherein the rear side direction is related to a side at which the cords are pulled. Said platform is manipulable to roll about said X-X axis (i.e. left/right tilting).

The terms left side and right side as used herein in the specification and claims define respective location along the lateral, Y-Y axis, wherein said platform is manipulable to pitch about said Y-Y axis (i.e. up/down, or as often referred to also as front/rear tilting). Accordingly, the terms front and rear, respectively refer to those sides of the system extending along the X-X axis

The X-Y plane is considered to be horizontal when the plane of the utility platform is transverse at right angles to the vertical axis (Z-Z) of the support post, regardless if the post is vertical.

The term cord connection element (CCE) is defined as one of:

i) a Static Cord Connection Elements (SCCE); wherein there is substantially no displacement of the cord with respect to the connection element (i.e. fixed thereto); and,

ii) a Dynamic Cord Connection Elements (DCCE); wherein the cord is displaceable with respect to the connection element (i.e. rolling/sliding); the term DCCE is used in s broad sense and also denotes a pulley or a motor, as defined herein.

The Cord Connection Elements are either articulated to the utility platform (in which case they are indexed P; e.g. PDCCE designates a utility platform mounted dynamic cord connection element), or to the ground (in which case they are indexed G; e.g. GSCCE designates a ground mounted static cord connection element).

The term pulley as used herein in the specification and claims is used in its broad sense and is used to denote any sort of hook through which a cord/cable extends and is free to slide/roll (change its point of application) and changes its direction. A pulley may be a simple hook or eye structure fixed to the utility platform or to the ground, or it may be a multiplication wheel-type pulley wherein force is traded for distance (i.e. a load is pulled over a longer distance, however at reduced force), etc.

In a system according to the present invention it is assumed that the tension cords are substantially non-stretchable (i.e. non-elongatable).

A motor as used herein in the specification and claims denotes any type of motor including, but not limited to linear retraction/expansion motors, rotary (winding) motors, winch, manipulators of various types, etc.

The present invention is directed to a structural support and tracking system which provides substantially accurate displacement/tracking, also upon displaced at substantially small increments. The manipulating construction is light weight and nevertheless provides rigidity and durability also at the event of strong wind. Even more so, the system may be tilted with respect to the horizon at significant degrees, optionally exceeding 90°.

The present invention is applicable to a wide range of radiation collector systems and to other systems which require precise one or two-axis tracking of a body. Examples for tracking systems are solar radiation collectors (in any form, e.g. flat panels, dish or trough-like), electromagnetic radiation collectors and the like. Another example of utility platforms is a vehicle simulator, motion simulator (e.g. ski simulator), aiming platform (e.g. for a weaponry system), double-deck car park or storage facility, etc.

According to the present invention there is provided a structural support and tracking system comprising a utility platform defining an X-Y plane and supported over a central support post defining a longitudinal axis Z being normal to the plane X-Y; said utility platform comprises at least three platform cord connection elements (PCCEs); at least three left ground cord connection elements (GCCEs) associated with two left platform cord connection elements (PCCEₗ), and at least one right ground cord connection element (GCCEᵣ) associated with at least one right platform cord connection element (PCCE); a tension cord system (TCS) wherein a cord extends from each platform cord connection element (PCCE) towards at least one corresponding ground cord connection element (GCCE); and a manipulating system for tilting the utility platform by tension adjustment of the cords.

Where only one cord extends between a ground cord connection element (GCCE) and a platform cord connection element (PCCE), thus said GCCE is provided at a right side of the system, and at least one of said PCCE and said GCCE is dynamic.

The structural support and tracking system is a dynamic tensegrity system, integrating balanced tension of the tension cords and compression of the support post. The system is such that the utility platform may acquire a tilt/angular displacement over its support post, at any increment and also at a continuous manner.

According to one particular design there is provided a structural support and tracking system comprising a utility platform defining an X-Y plane and supported over at least one support post defining a longitudinal axis Z being normal to the plane X-Y; said utility platform comprises at least four platform cord connection elements (PCCEs) extending on the circumcircle of said utility platform and being equiangularly disposed thereabout; two rear ground cord connection elements (GCCEs) disposed below said utility platform such that at a horizontal position of the X-Y plane said rear GCCEs extend below rear PCCEs, respectively, and at least one front ground fixed CCE (GSCCE) extends on a radius of at least an inscribed circle but not more than the radius of circumcircle of said utility platform; a tension cord system (TCS) wherein a cord extends from each platform CCE towards a rear ground CCE at an X-Z plane, and a cord extending from each platform CCE towards said at least one front ground GCCE; and a manipulating system for at least roll tilting of the utility platform by tension adjustment of four cords extending from the two rear GCCEs.

In the particular example above, where a static cord connection element is provided, the cord is split into a first cord segment and a second cord segment, each of said segments extending from the SCCE, towards a DCCE. Likewise, a static cord connection element may consist of two adjoining static cord connection elements, each associated with a cord extending towards a DCCE.

Any one or more of the following features of the invention may be incorporated with a system according to the invention:
where the system comprises three pairs of tension cord systems (TCS), then a right tension cord system has a centrally positioned platform cord connection element (PCCE), with one of the following modules:
   the right PCCE and both corresponding ground GCCEs are dynamic;
   the right PCCE is dynamic and one of the corresponding GCCEs is dynamic and the other GCCE is static;
   the right PCCE is static and both the corresponding GCCE are dynamic;
   one ground CCE of the two left tension cord systems is static (GSCCE);
the system may comprise two front ground cord connection elements, each extending below said utility platform such that at a horizontal position of the X-Y plane the two front ground cord connection elements extend below corresponding two front platform cord connection elements, respectively.
the Z axis is concentric with the center of the utility platform.
the at least three platform cord connection elements PCCEs and the at least three ground cord connection elements GCCEs extend on the circumcircle of said utility platform.
the at least three ground cord connection elements extend beyond the circumcircle of the utility platform;
at least two pairs of tension cord systems are parallel to one another, either at substantially the same plane or at parallel planes disposed at opposite sides of the system. However non-parallel configurations are possible too;
a uniform, continuous cord extends at the same side of the utility platform configure a ∞ like shape. Where more than two dynamic cord connection elements (e.g. pulleys) are provided at each side edge of the utility platform, with corresponding ground dynamic cord connection elements, the continuous cord at each side has a zigzagging shape when viewed at an X-Z plane. Such a shape is for example
two ends of the continuous cord each extend to said manipulating system.
each end of the continuous cord is associated with a winding motor, said system comprising a total of at least two winding motors, the arrangement being such that each cord maybe independently tensioned or extended therefrom. Where only two motors are provided thus two cord ends extend to the same motor, though coupled so as to oppositely wind/release.
wherein the manipulating system comprises a gear system associated with at least one motor for selective tensioning/dispensing the cords.
the support post is axially extendible/retractable.
The support post extends vertically along the Z axis;
the utility platform is yaw-stabilized.
the utility platform is fitted to the support post via a coupling link rendering it freedom to tilt at an angle of at least 90° with respect to the X-Y plane.
the system may further comprise a computerized controller adapted for receiving an input signal correlative to a required pitch/roll tilt of the utility platform, said controller emitting a control signal to said manipulating system, responsive to said input signal, for respective tensioning/dispensing the cords.
the support post comprises a dampening mechanism facilitating to retain the utility platform substantially stable at a respective tilts position thereof.
the utility platform is a solar radiation mirror assembly being part of a heliostats array.
the utility platform is a solar PV panel.
the utility platform is a electromagnetic radiation collector.
the platform CCEs extend at an angle between the X-X axis and the Y-Y axis. According to a particular design, said angle is a bisector between the X-X axis and the Y-Y axis.
one or more of the platform cord connection elements and ground cord connection elements are fitted with a force reducing/increasing mechanism.
the support post extends at least the radius of the circumcircle of said utility platform. This is required to enable tilting at angles nearing or exceeding 90°. However, the support post may be shorter in cases where less than <90° tilting is required or where the utility platform has a prior offset (e.g. shifted to the south).
the manipulating system is fitted with a cord tensioning mechanism, such as a mechanical spring, a pneumatic spring, magnetic spring, etc.
one or more brake mechanisms are associated with each cord, to arrest the cords and prevent free displacement through the dynamic cord connection element. Where a brake mechanism is provided a respective cord may be arrested at any position with respect to the cord connection element or to the support structure, respectively.
the support post may be a-priori inclined relative to the Z axis, or it may be fitted over a pivot and a tilting mechanism for tilting about the Z axis.
where two tension cord systems (TCSs) extend substantially parallel to one another along right and left edges of the system respectively, there may be at least one cord segment of one or both said TCSs diagonally extending towards the other of said TCS.
It is appreciated that the system is substantially light weight, though is suited for bearing heavy loads of the utility platform and for example wind. On the other hand the system may rapidly assume a stowed position in case of strong wind, whereby the utility platform is directed so as to cause a minimal disturbance to the wind.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a schematic perspective representation of a basic support system in accordance with an embodiment of the invention, comprising three tension cord systems (TCSs), illustrating geometry of the system;

FIGS. 2A to 2D are schematic illustrations of four modifications of the support system in accordance with an embodiment of the invention, comprising three pairs of tension cord systems;

FIGS. 3A to 3C illustrate three respective positions of the support system according to an embodiment similar to that schematically illustrated in FIG. 2C;

FIG. 4 is a schematic perspective representation of a support system in accordance with an embodiment of the invention, comprising four pairs of cord connection elements, specifying the geometry and directions mapping of the system;

FIG. 5A is a top perspective view of a support system in accordance with the embodiment of FIG. 4;

FIG. 5B is a schematic top presentation of a system of FIG. 5A;

FIG. 6A is a top perspective view of a support system in accordance with another embodiment of the invention, comprising four platform cord connecting elements and three ground connecting elements;

FIG. 6B is a top schematic representation of the embodiment of FIG. 6A;

FIG. 7 is a schematic representation of a particular example of the invention;

FIGS. 8A to 8H are schematic representations illustrating how tensioning/dispensing cords influence tilting of the support structure of the system according to an embodiment of the present invention;

FIG. 9 is a schematic illustration showing only a right side tension cord system, in accordance with a modification of the invention;

FIG. 10 is a schematic illustration showing only a right side tension cord system, in accordance with yet a modification of the invention;

FIG. 11 is a schematic illustration showing only a right side tension cord system, in accordance with another modification of the invention;

FIG. 12A is a top, rear perspective view of a system according to a further embodiment of the present invention;

FIGS. 12B to 12D illustrate a modification of a system according to the embodiment of FIG. 12A, at respective orientations;

FIGS. 13A and 13B are top, rear perspective views of a system according to still further modifications of the present invention; and

FIG. 14 is a schematic rear isometric view of yet a different example of a system according to the present invention.

### DETAILED DESCRIPTION OF SPECIFIC EMBODIMENTS

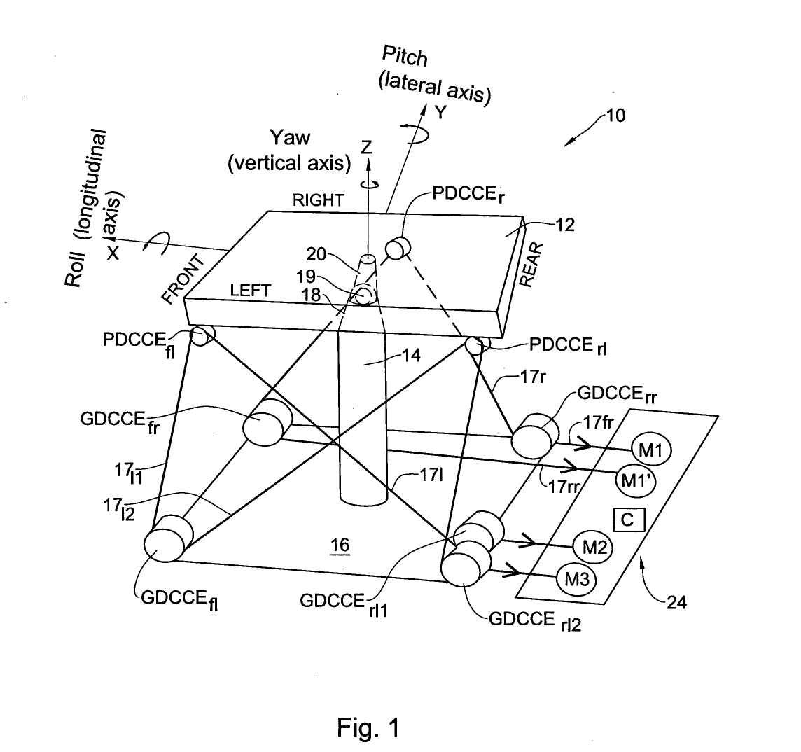

Turning first to FIG. 1 of the drawings there is schematically illustrated a structural support/tracking system in accordance with the present invention generally designated 10, comprising a utility platform 12 which in the present case is a flat, rigid, rectangle plate tiltably supported over a support post 14 rigidly fixed to the ground surface 16, via a first joint 18, a support link 19 and a second free joint 20 (e.g. a ball and socket joint with extension link, universal joint, Cardan joint, etc.). The link and joints enable the utility platform 12 to tilt at 90° or more.

The utility platform 12 is defined over a longitudinal axis X and a lateral axis Y. The utility platform 12 further defines a front side and a rear side extending along the longitudinal X-X axis. A manipulating system generally designated 24 comprises three motors M₁, M₂ and M₃ and a controller assembly C, to be discussed hereinafter in further detail. The longitudinal axis X-X is the axis about which the utility platform 12 rolls. The utility platform further has defined a left side and right side extending along the lateral Y-Y axis about which the utility platform is designed to pitch.

Accordingly, the vertical axis Z is the direction about which the utility platform 12 yaws.

A right tension cord system (TCS) 17ᵣ extending between a dynamic rear right ground cord connection element (GDCCEᵣᵣ), a dynamic right platform cord connection element (PDCCEᵣ) and a dynamic front right ground cord connection element (GDCCE_{fr}), said cord having two ends 17_{fr} and 17ᵣᵣ coupled to a respective manipulating motor assembly (i.e. each end is articulated to a respective spool of a motor M₁ and M_{1′}, or to oppositely directed spools of the single motor M₁).

A left tension cord system (TCS) 17₁ is composed of two cooperating sub-tension cord systems 17₁₁ and 17₁₂ which together have an ∞ resembling pattern. Tension cord systems 17₁₁ and 17₁₂ are substantially coplanar and parallel to the right tension cord system 17ᵣ.

The left tension cord system 17₁₁ comprises cord section extending from a rear left dynamic ground cord connection element GDCCEᵣ₁ (coupled to a respective manipulating motor assembly M₂) towards a rear left dynamic platform cord connection element PDCCEᵣ₁ and then through a front left dynamic cord connection element GDCCE_{fl}. From there the cord continues (as part of the second left tension cord system 17₁₂) towards the rear left dynamic platform cord connection element (PDCCEᵣ₁) from where it extends down through an other GDCCEₗᵣ and extends towards a manipulating motor assembly M₃.

The arrangement is such that tensioning one or more of the cords 17ᵣ₁, 17ᵣ₂ 17₁₁ or 17₁₂, while simultaneous loosening the tension in the other of the one or more cords, will result in corresponding tilt of the utility platform 12 about the post 14, however maintaining the cords substantially under constant tension. Such tilting is gradual and continuous (as opposed to incremental), may be at substantially small increments, and the utility platform 12 may acquire practically any desired orientation. Even more so, the provision of the controller assembly C provides real-time information regarding a plurality of parameters such as position of the utility platform 12, tension in the cords, external forces acting on the system (e.g. wind, payload mounted thereon, etc.), and the controller also provides the required signals for operation of the motors so as to obtain the desired position of the utility platform 12.

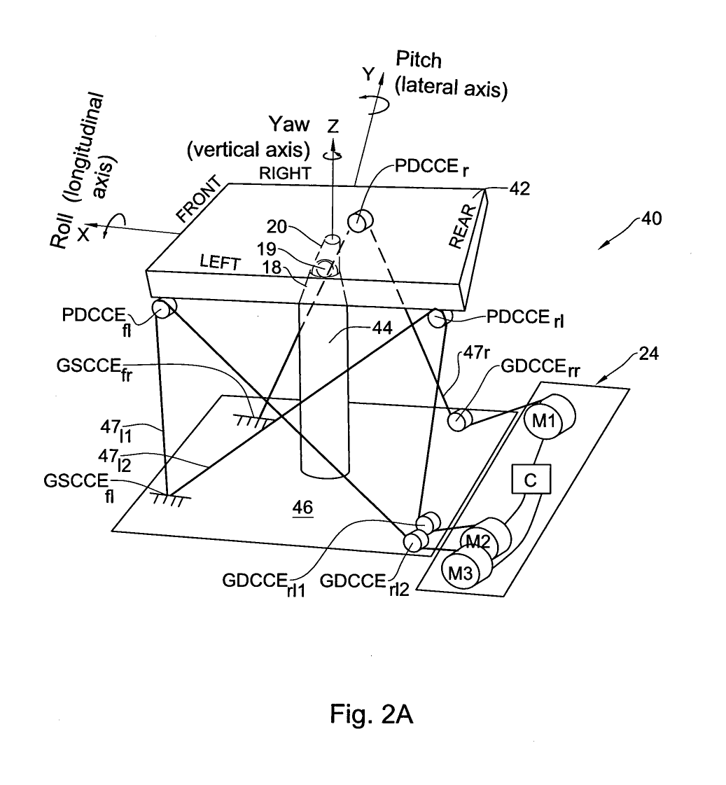

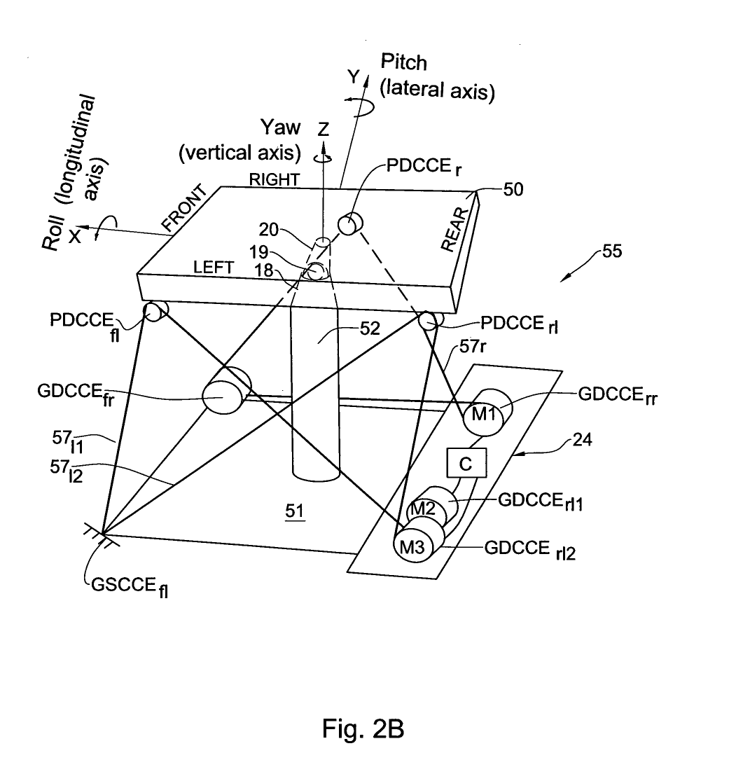

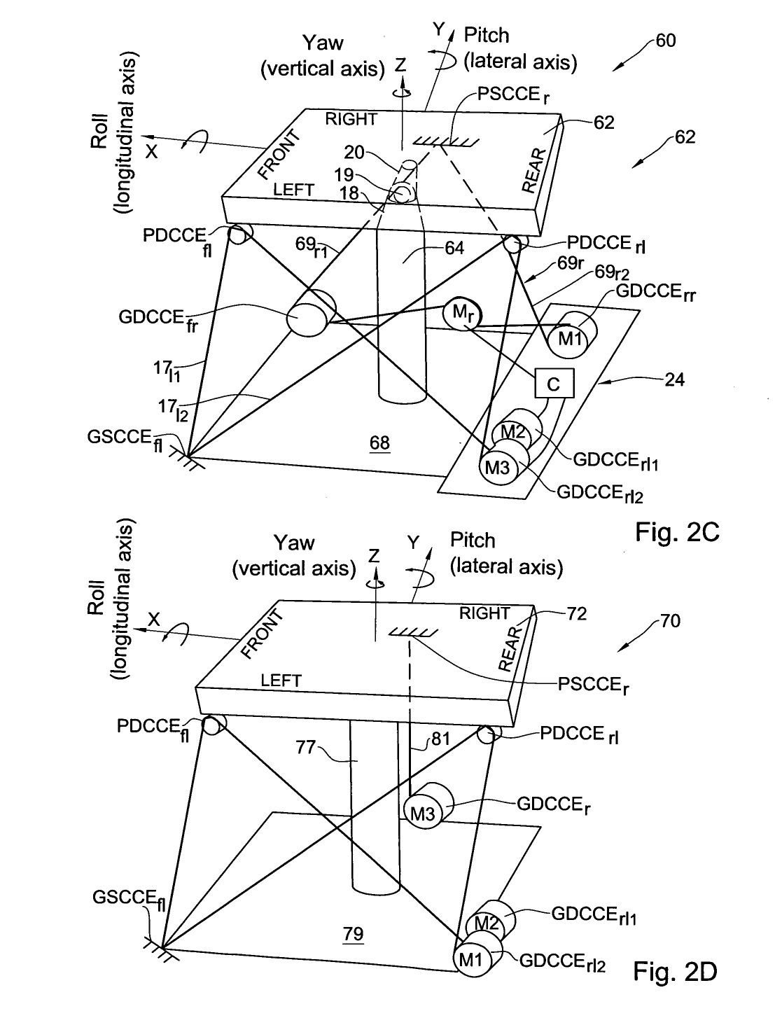

Turning now to FIGS. 2A to 2C there are illustrated three modifications of the embodiment exemplified in connection with FIG. 1, wherein like elements have been likewise named.

In FIG. 2A there is illustrated a structural support/tracking system 40 comprising a utility platform 42 tiltably supported (at 90° or more) over a support post 44 rigidly fixed to the ground surface 46.

A right cord system has a cord 47ᵣ fixedly articulated at one end to the ground surface 46 at a static cord connection element GSCCE_{f}r, said cord 47ᵣ extending through a platform dynamic cord connection elements PDCCEᵣ substantially centrally disposed about a right edge of the utility platform 42, with an other end of the cord extending through a ground dynamic cord connection elements GDCCEᵣᵣ in the form of a pulley, said cord further coupled to a motor M₁.

Likewise, a first left cord assembly comprises a cord 47₁₁ extending from a ground static cord connection element GSCCE_{fl} disposed at the front left side of the ground surface 46 towards a platform front right dynamic cord connection elements PDCCE_{fl}, and then extends through a ground dynamic cord connection elements GDCCEᵣₗ₁ in the form of a pulley, said cord further coupled to a motor M₃.

A second left cord assembly comprises a cord 47₁₂ extending from the common ground static cord connection element GSCCE_{fl}, extending towards a rear left dynamic cord connection elements PDCCEᵣₗ, and then extends through a ground dynamic cord connection elements GDCCEᵣₗ₂ in the form of a pulley, said cord further coupled to a motor M₂.

In FIG. 2B there is illustrated a structural support/tracking system 55 comprising a utility platform 50 tiltably supported (at 90° or more) over a support post 52 rigidly fixed to the ground surface 51.

A right cord assembly comprises a cord 57ᵣ extends from a motor M₁ towards a platform dynamic cord connection element PDCCEᵣ (substantially centrally positioned at a right edge of the utility platform 50) and further the cord 57ᵣ extends towards a front right dynamic ground cord connection elements GDCCE_{fr} and back towards the motor M₁ serving as a right dynamic ground cord connection elements GDCCEᵣᵣ.

A first left cord system comprises a cord 57₁₁ fixedly articulated at one end to the ground surface 51 at a static cord connection element GSCCE_{fl}, said cord 57₁₁ extending through a platform dynamic cord connection element PDCCEᵣₗ fitted at a rear left corner of the utility platform 50, said cord 57ᵣ₁ further extending through a ground dynamic cord connection elements GDCCEᵣₗ₁ in the form of a motorized pickup pulley.

A second rear cord system comprises a cord 57₁₂ commonly fixedly articulated at one end to the ground surface 51 at said static cord connection element GSCCE_{fl}, said cord 57₁₂ extending through a platform dynamic cord connection element PDCCEᵣₗ fitted at a front left corner of the utility platform 50, said cord 57₁₂ further extending through a ground dynamic cord connection elements GDCCEᵣₗ₂ in the form of a motorized pickup pulley.

It is noted that in the particular example, the static cord connection element GSCCE_{fl} is common to both cord systems 57₁₁ and 57₁₂, though according to a modification, each cord may extend from a separate CCE.

The example illustrated in FIG. 2C resembles that of FIG. 2B and discloses a structural support/tracking system 60 comprising a utility platform 62 tiltably supported (at 90° or more) over a support post 64 rigidly fixed to the ground surface 66.

A right cord assembly comprises a cord 69ᵣ is fixedly articulated at a platform static cord connection element PSCCEᵣ (substantially centrally positioned at a front edge of the utility platform 62) with one segment of the cord 69ᵣ₁ extending towards a front right dynamic ground cord connection elements GDCCE_{fr} in the form of a pulley, and an other segment of the cord 69ᵣ₂ extending towards a rear right dynamic ground cord connection elements GDCCEᵣᵣ, wherein both said ends extend towards a central, common motor Mᵣ, wherein rotating the motor in one direction entails tensioning one cord 69ᵣ₁ and simultaneous releasing the other end of cord 69ᵣ₂ and vise versa. Whilst cord 69_{f} is illustrated as having two segments (69ᵣ₁ and 69ᵣ₂), both extending from the common PSCCEᵣ, it is appreciated that separate cords may extend form a single or adjoining SCCE.

The right and rear cord systems 71₁₁ and 71₁₂ of the embodiment of FIG. 2C are configured similar to the arrangement disclosed in connection with the example of FIG. 2B, and act similarly.

Turning now to the example illustrated in FIG. 2D, there is illustrated a structural support/tracking system 70 similar to that disclosed in connection with FIGS. 2A to 2C, comprising a utility platform 72 tiltably supported (at 90° or more) over a support post 77 rigidly fixed to the ground surface 79.

The left tension cord system (TCSₗ) is identical with that disclosed in connection with the previous examples of FIGS. 2A to 2C. However, in the present example the right tension cord system (TCSᵣ) is constructed with only one cord 81 extending between a right dynamic ground cord connection element (DGCCEᵣ) (e.g. motorized pulley) and a static right platform cord connection element (PSCCEᵣ). However it is appreciated that the dynamic component may be either at the platform side or at the ground side.

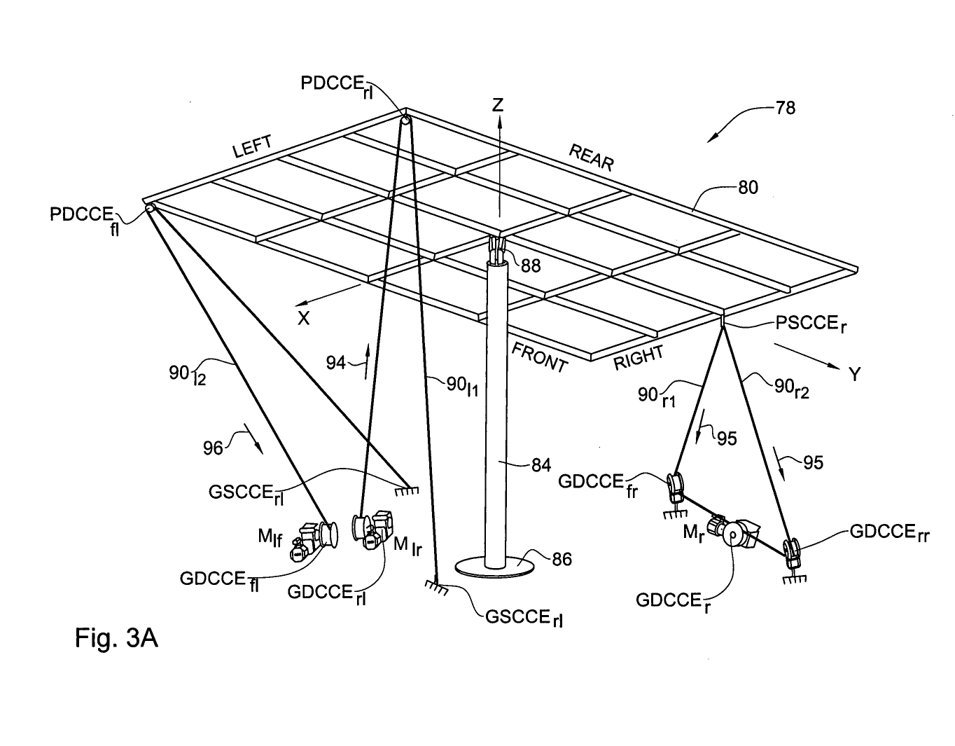

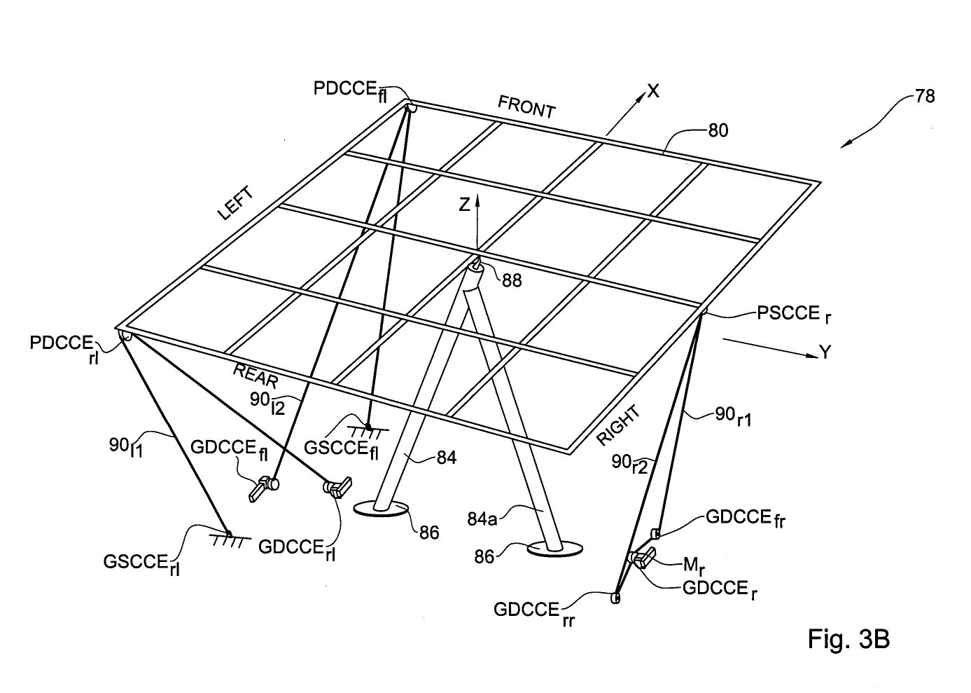

FIGS. 3A to 3C schematically illustrate three respective positions of a structural support/tracking system according to an embodiment similar to that schematically illustrated in FIG. 2C. The structural support/tracking system generally designated 78 comprising a utility platform 80 tiltably supported (at 90° or more) over a support post 84 rigidly fixed to the ground surface 86 by a pivot hinge 88.

A right cord assembly comprises a cord 90ᵣ is fixedly articulated at a platform static cord connection element PSCCEᵣ (substantially centrally positioned at a right edge of the utility platform 80) with one cord segment 90ᵣ₁ extends towards a front right dynamic ground cord connection elements GDCCE_{fr} in the form of a pulley, and an other cord segment 90ᵣ₂ extends towards a rear right dynamic ground cord connection elements GDCCEᵣᵣ, wherein both said cord segment 90ᵣ₁ and 90ᵣ₂ extend towards a central, common motor Mᵣ, coupled to a spool GDCEEᵣ wherein rotating the motor Mᵣ entails simultaneous tensioning one of the segments of the cord and releasing the other segment, and vise versa.

A first left cord system comprises a cord 90₁₁ fixedly articulated at one end to the ground surface 86 at a static cord connection element GSCCEᵣₗ, said cord 90ₗ₁ extending through a platform dynamic cord connection element PDCCEᵣₗ fitted at a rear left corner of the utility platform 80, and further extending through a ground dynamic cord connection elements GDCCEᵣₗ in the form of a pickup pulley articulated to a front left motor Mₗᵣ.

A second left cord system comprises a cord 90₁₂ is fixedly articulated at one end to the ground surface 86 at a static cord connection element GSCCEᵣₗ, said cord 90₁₂ extending through a platform dynamic cord connection element PDCCE_{fl} fitted at a front left corner of the utility platform 80, and further extending through a ground dynamic cord connection elements GDCCE_{fl} in the form of a pickup pulley articulated to a rear left motor M_{lf}.

Whilst the system illustrated in FIGS. 3B and 3C is similar to that illustrated in FIG. 3A however, in FIGS. 3B and 3C the central post 84 is inclined and supported by a support post 84a.

Furthermore, whilst in FIG. 3A the utility platform is mildly inclined so that its front side is lowered, in FIG. 3B the utility platform 80 is at a substantially horizontal position, which is useful to dispose the utility platform in case of extreme winds, and in FIG. 3C is extending at an approximately upright position. This position is useful, for example, for maintenance, etc.

Considering the substantial horizontal position illustrated in FIG. 3B as the position of origin (‘reference position’), thus the position of FIG. 3A is obtained by unwinding the rear left motor Mₗᵣ so as to release the cord 90ᵣ₁ as indicated by arrow 94 (i.e. elongate it), whilst simultaneously tensioning both right cord segments 90ᵣ₁ and 90ᵣ₂ by means of motor Mᵣ (arrows 95) and the rear left cord 90ₗ₂ (arrow 96) by means of the rear left motor M_{lf}.

Manipulating the utility platform 80 into the position of FIG. 3C is facilitated by unwinding the rear right motor Mₗᵣ so as to release the cord 90ₗ₂ as indicated by arrow 97 (i.e. elongate it), whilst simultaneously tensioning the left cord 90ₗ₂ by means of motor M_{fl} (arrow 96)

Whilst not mentioned, each of the disclosed examples is associated with a controller unit (designated C in FIG. 1A) as mentioned herein above. Obtaining a particular orientation of the utility platform and its displacement is controlled by such a controller assembly which continuously acquires signals representative of various parameters (e.g. utility platform orientation, tension in cords, motors' status, etc), and responsive thereto, generates respective signals to the motors to wind/unwind, depending on the desired position of utility platform.

In the embodiments and examples hereinafter, the utility platform is always fitted with four Platform Dynamic Cord Connection Elements (PDCCEs), whilst there are provided three or four Ground Cord Connection Elements (GCCEs), depending on the case.

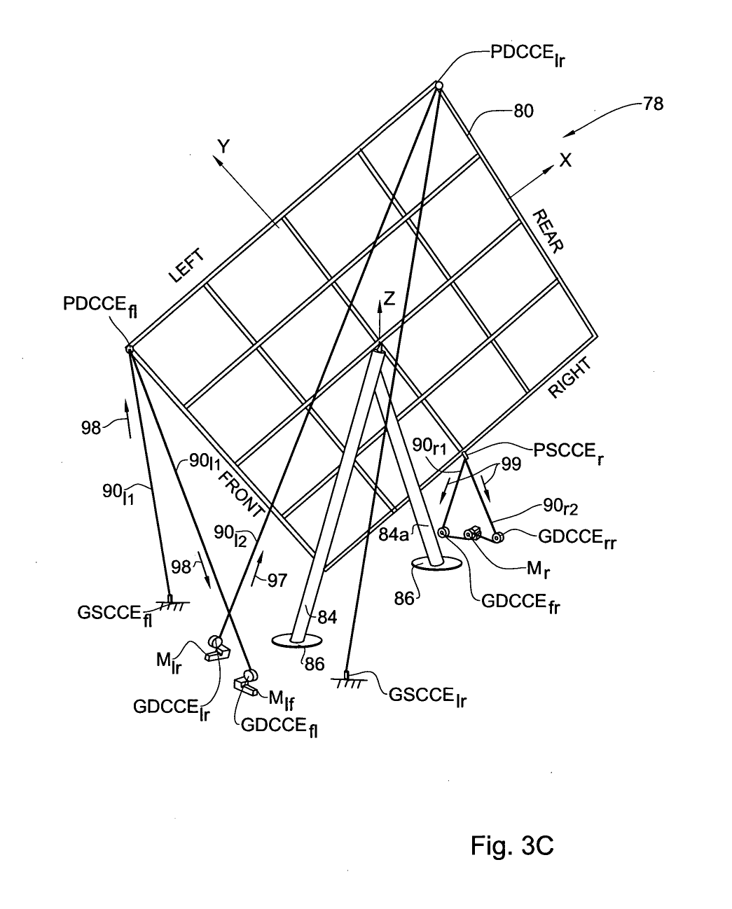

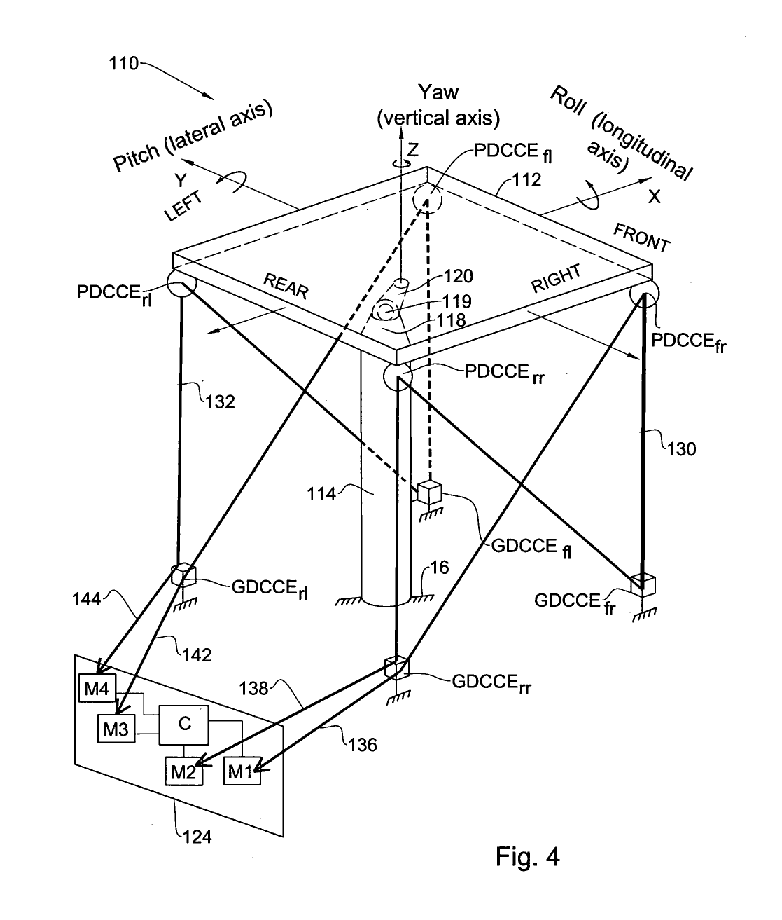

Turning now to FIG. 4 of the drawings the structural support/tracking system is generally designated 110 and similar to the previous examples comprises a utility platform 112 which in the present case is a flat, rigid, rectangle truss—type plate 112 tiltably supported over a support post 114 rigidly fixed to the ground surface 116, via a first joint 118, a support link 119 and a second free joint 120 (e.g. a universal joint). The link and joints enable the utility platform 112 to tilt at 90° or more.

The utility platform 112 is defined over a longitudinal axis X and a lateral axis Y. The utility platform 112 defines a front side and a rear side extending along the longitudinal X-X axis. A manipulating system generally designated 124 comprises three motors M and a controller assembly C, to be discussed hereinafter in further detail. The longitudinal axis X-X is the axis about which the utility platform 112 rolls. The utility platform further has defined a left side and right side extending along the lateral Y-Y axis about which the utility platform is designed to pitch. Accordingly, the vertical axis Z is the direction about which the utility platform 112 yaws.

The utility platform is fitted at its respective corners with four platform cord connection elements, in the form of pulleys and designated a follows:

Front right platform pulley—PCCE_{fr};

Rear right platform pulley—PCCEᵣᵣ;

Front left platform anchor—PCEE_{fl}; and Rear left platform pulley—PCEEᵣₗ.

The term pulley is used in its broad sense, however, fitted for a cord to extend therethrough and change its direction, as will become apparent hereinafter. A pulley may be provided with one or more friction reducing wheels or it may be devoid of any wheels.

As can further be noted in FIG. 4 the system 110 comprises four Ground Cord Connection Elements (GCCEs) fixedly secured to the ground surface 116, said ground pulleys designated as follows:

Front right ground platform—GCCE_{fr};

Rear right ground platform—GCCEᵣᵣ;

Front left ground platform—GCCE_{fl}; and

Rear left ground platform—GCCEᵣₗ.

The four Platform Cord Connection Elements (PCCEs) are schematically illustrated in the following drawings as circles, as opposed to the Ground Cord Connection Elements (GCCEs), represented by squares.

Noting that two cord ends extend rearwards, the rear ground pulleys GCCEᵣₗ and GCCEᵣᵣ are each configured as double pulleys, or as two separate pulleys each receiving a cord's free end. As mentioned hereinabove, the one or two front ground cord connecting elements may either be a pulley facilitating rolling of the respective cord therethrough, i.e. a dynamic CCE designated DCCE, or a fixture wherein the respective cord is fixedly anchored with respect to the ground, i.e. a static CCE designated SCCE.

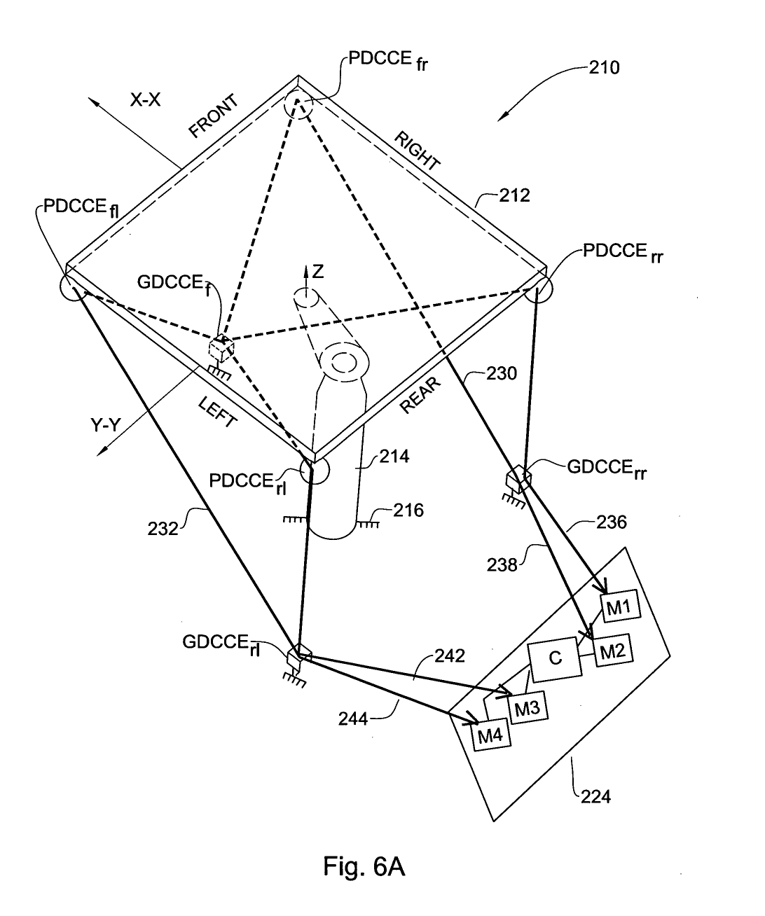

The four ground cord connecting elements GCCEs are disposed substantially below the utility platform PCCEs, respectively. However, as will become apparent in connection with the embodiment of FIGS. 6A and 6B, the system may comprise only three ground cord connecting elements GCCEs, otherwise disposed.

A tension cord system is provided, wherein a first continuous, non elongatable cord 130 extends at the right side of the system, and a similar cord 132 extends at the left side of the system, both tension cord systems 130 and 132 extending substantially at an X-Z plane of the system. As can be seen in FIG. 4 the right tension cord system 130 has a first end 136 engaged with a first motor M1 of a manipulating system generally designated 124 from which the cord 130 extends through the GDCCEᵣᵣ, and then passes through the PDCCE_{fr}, from which it extends through the GDCCE_{fr} and then through the PDCCEᵣᵣ, back down through the GDCCEᵣᵣ with its other end 138 being securely engaged with a second motor M2 of the manipulating system 124.

Likewise, the left tension cord system 132 has a first end 142 engaged with a third motor M3 of the manipulating system 124 from which the cord 132 extends through the GDCCEᵣₗ, then through the PDCCE_{fl}, down to the GDCCE_{fl}, then through the PDCCᵣₗ and back through the GDCCEᵣₗ where the second end 144 of the cord 132 is secured to a force motor M4 of the manipulating system 124.

As already mentioned hereinabove, the motors M1 to M4 may be of any one or more type such as, for example, rotary (winding) motors, linear retraction/expansion motors (i.e. piston-type motors), etc. Furthermore, in the embodiment disclosed in FIG. 4 the cords are each associated with an individual motor. However, in accordance with other embodiments (see for example FIGS. 3A to 3C) one motor may serve for two cords ends e.g. by providing a suitable gear system or by winding the cords in opposite directions.

It is further noticed that the manipulating system 124 comprises a controller C associated with each of the motors M1 to M4 for tensioning/dispensing the respective cords. Thus, there is provided a computerized processor receiving an input data from a sensor S (positioned on the utility platform 112 and transmitting data to the controller C) correlating with the desired tilt angle of the utility platform 112 and responsive thereto emitting a control signal to each of the associated motors M1 to M4 to thereby activate the appropriate direction in order to attain the required tilt of the utility platform 112. The manipulating system 124 further comprises cord tension sensors and respective cord tension mechanism for maintaining the cords tense.

In order to maintain tension of the cords, a cord tensioning mechanism may be introduced, e.g. within or adjacent the motor units, or at other locations along the cords. Such a tensioning mechanism may be, for example, a mechanical spring, a pneumatic spring, magnetic spring, etc.

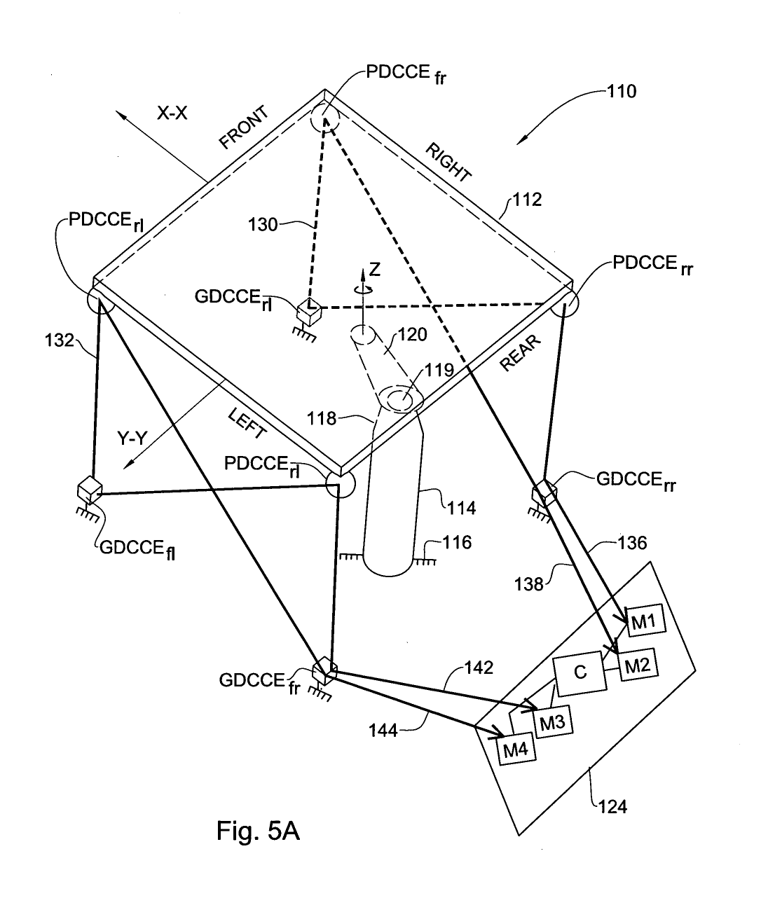

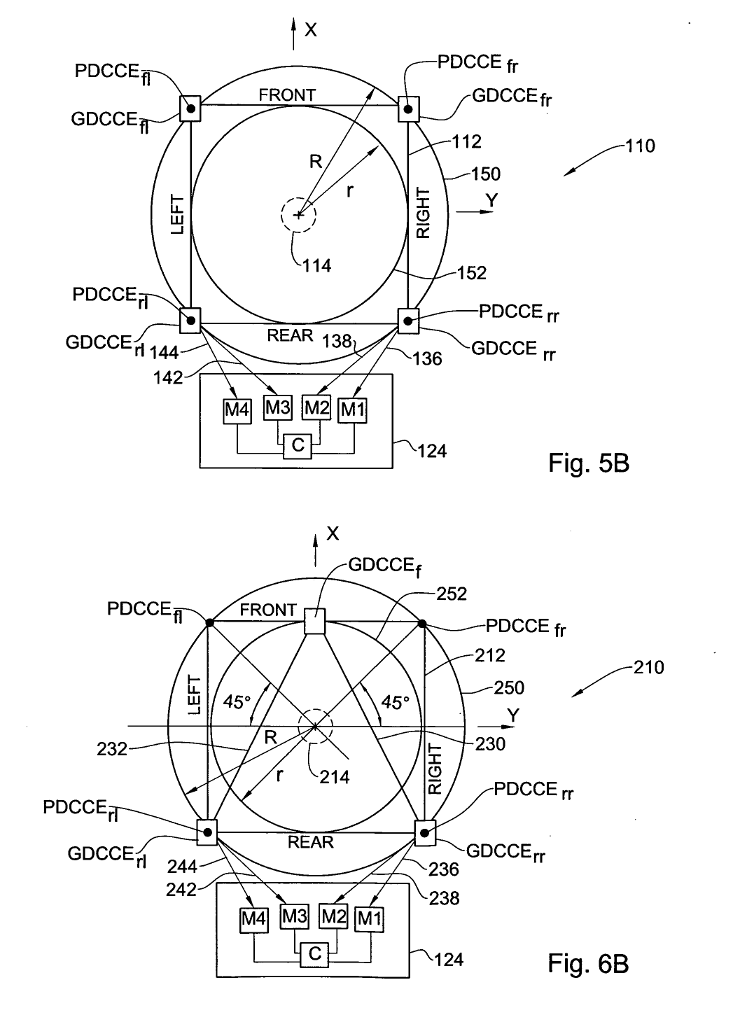

FIG. 5A illustrates a structural support and platform system 110 in accordance with the embodiment illustrated in FIG. 4 however illustrated from another direction for sake of clarification. It is clearly noted in FIGS. 4 and 5A that each of the tension cords systems 130 and 132 form a ∞-like configuration.

With further reference to FIG. 5B there is illustrated a schematic top planar view of the structural support and tracking system 110 in accordance with the embodiment of FIGS. 4 and 5A for further clarification. It is noticed that the utility platform 112 is rectangular as mentioned hereinabove, however, it may assume different forms and may be for example a hemispherical collector dish and the like. However, the utility platform 112 defines a circum circle 150 and an inscribed circle 152, the arrangement be such that the four platform cord connectors PDCCE_{fr}, PDCCE_{fl}, PDCCEᵣᵣ and PDCCEᵣₗ, as well as the corresponding ground cord connectors GDCCE_{fr}, GDCCE_{fl}, GDCCEᵣᵣ and GDCCEᵣₗ, all extend at respective corners of the utility platform 112 thus laying on the circum circle 150 having a radius R.

Turning now to FIGS. 6A and 6B there is illustrated a different embodiment of the structural support and tracking system in accordance with the present invention, generally designated 210.

For sake of clarity, elements similar to those disclosed in connection with FIG. 1 are designated with like reference number, however, shifted by 200

The significant difference between the embodiment of FIGS. 6A and 6B as compared with the previous embodiments, resides in the construction and positioning of the ground cord connecting elements GCCEs.

As noticed, two tension cord systems are provided namely tension cord 230 associated with the right side of the system, and tension cord 232 associated with the left side of the system.

However, it is noticed that instead of the front right ground CCE and the front left CCE each extending below a respective corner of the utility platform 212, in the embodiment of FIG. 6A there is provided a single dynamic front ground cord connector GDCCE_{f} wherein both cords 230 and 232 extend through said GDCCE_{f}. It is appreciated that instead of a single centralized ground CCE there may be provided a double CCE, however centrally located below the front edge of the utility platform 212.

It is thus seen that the first free end 236 of the tension cord 230 extends from a first motor M1 through the rear right DGCCEᵣᵣ, up through the PDCCEᵣᵣ, then down towards the single ground cord connector GDCCE_{f} wherefrom it extends through the PDCCE_{fr}, then back through the DGCCEᵣᵣ from which the second free end 238 extends to a second tension motor M2.

Likewise, the left tension cord 232 has its first free end 242 articulated to a tension motor M3 from which it extends through a right left ground cord connector GDCCEᵣₗ, from which it extends up towards the rear left cord connector PDCCEᵣₗ then down to the common single front ground connector GDCCE_{f} (which in this particular case is common with the tension cord 230, however, each of the cords 230 and 232 is free to independently, substantially frictionless roll through said GDCCE_{f}. From the GDCCE_{f} the cord 232 extends up to the front left cord connector PDCCE_{fl}, then back to the rear left ground cord connector GDCCEᵣₗ from which the second free end 244 extends and is linked to the fourth motor M4 of the manipulating system 224

In the embodiment of FIG. 6A the continuous cords 230 and 232 also configure form a co-like configuration when viewed from one of the sides (X-Z plane).

Turning now to FIG. 6B the system 210 is illustrated at a top elevation and it is noticed that the four platform cord connectors PCCEs namely PDCCEᵣᵣ, PDCCEᵣₗ, PDCCE_{fr} and PDCCE_{fl} all extend at respective corners of the utility platform 212 and accordingly, are disposed on the circum circle 250 of radius R. However, it is noticed that in this particular case the single front ground cord connector GDCCE_{f} is centrally aligned on the X axis below a front edge of the utility platform 212 and thus extends on the inscribed circle 252 of radius r. As for the rear ground cord connectors namely GDCCEᵣᵣ and GDCCEᵣₗ, those extend below the respective rear corners of the utility platform 212 namely on the circum circle 250

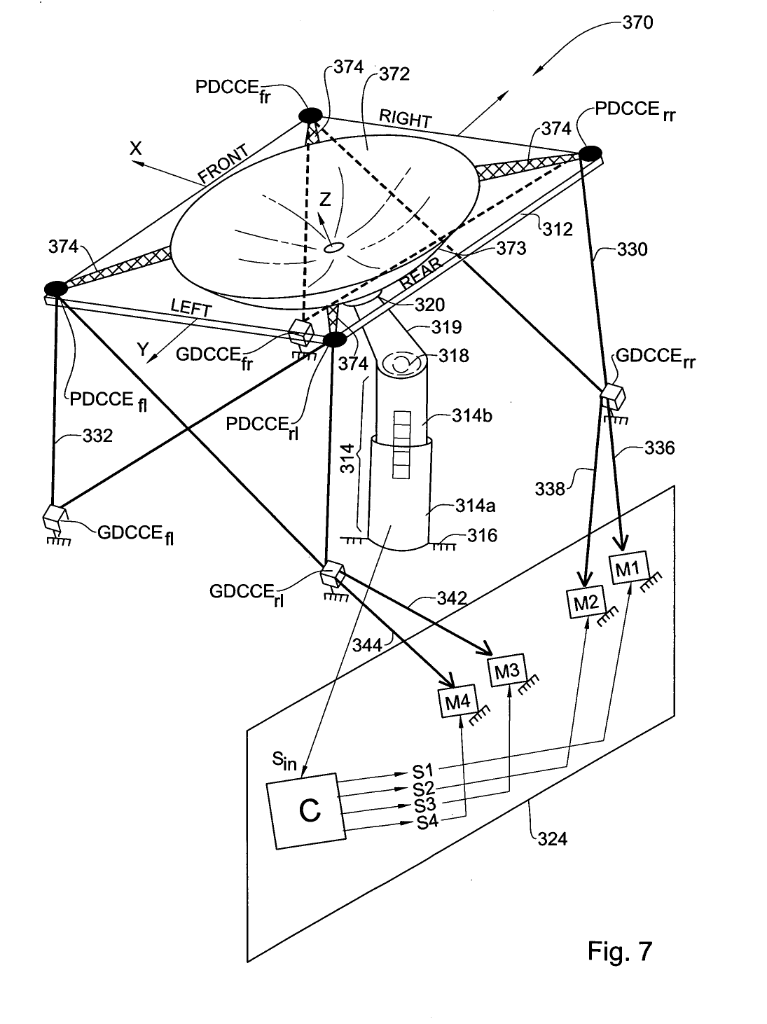

Turning now to the embodiment illustrated in FIG. 7 there is illustrated a radiation collector system generally designated 370 wherein like elements as in the embodiment of FIG. 1 are designated with like reference numbers, however, shifted by 300

The radiation collector system 370 may be for example a tracking solar radiation collector dish or an electromagnetic radiation collector dish, etc.

In the present example, the utility platform is in the form of a collector dish 372 which for sake of clarity is imposed over a rectangular utility platform 312 It is however, noted that the collector dish 372 is mounted on a rigid truss comprising rigid lateral projecting arms 374 each of which extending towards the corners of the rectangle platform designated 312

The collector dish 372 is mounted on a support post generally designated 314 composed of a bottom portion 314a fixedly secured to the ground surface 316 and a top post component 314b wherein the top post component 314b is telescopically displaceable with respect to the bottom post component 314a to thereby change the overall height of the support post 314 Extending at the top of the top support post 314b there is a link arm 319 pivotally coupled via a ball-type, universal or other type joint 320 to a bottom surface 373 of the collector dish 372.

Similar to the arrangement disclosed in connection with FIGS. 4 and 5 the utility platform (radiation dish in the present example) is fitted with four platform cord connector elements PCCEs designated in the same manner as disclosed in the previous embodiments, and extending above corresponding ground cord connector elements GCCEs as discussed hereinabove and designated herewith like names.

Two tension cord systems are provided namely 330 and 332 one extending on the right side of the system and the other extending on the left side of the system as explained in connection with the previous embodiments. The free ends 336; 338 and 342, 344 and of the left and right tension cord systems 330 and 332 respectively, extend towards the manipulating system 324 which in turn comprises four motors M1, M2, M3 and M4 each articulated for tensioning-dispensing the respective free ends of the cords. The manipulating system 324 further comprises a computerized controller generally designated C designed for receiving an input signal Sᵢₙ corresponding with the azimuth of the collector dish 372 which in turn is fitted with a heliostat sensor mechanism for determining the azimuth towards the source of radiation (e.g. sun, satellite, etc.). in this example the signal Sᵢₙ is transmitted e.g. in a wireless fashion, or otherwise transferred, to the controller C. The computerized controller C then calculates the respective direction at which the dish 372 is to be tilted and generates a series of responsive signals S₁, S₂, S₃ and S₄ to each of the respective motors M1, M2, M3 and M4 to either tension or dispense the respective cords, until the radiation dish 372 acquires its desired position. The computerized controller C also can control the height of the post by axial displacement of the top post component 314b with respect to the bottom post component 314a, to thereby change the height of the support post 314

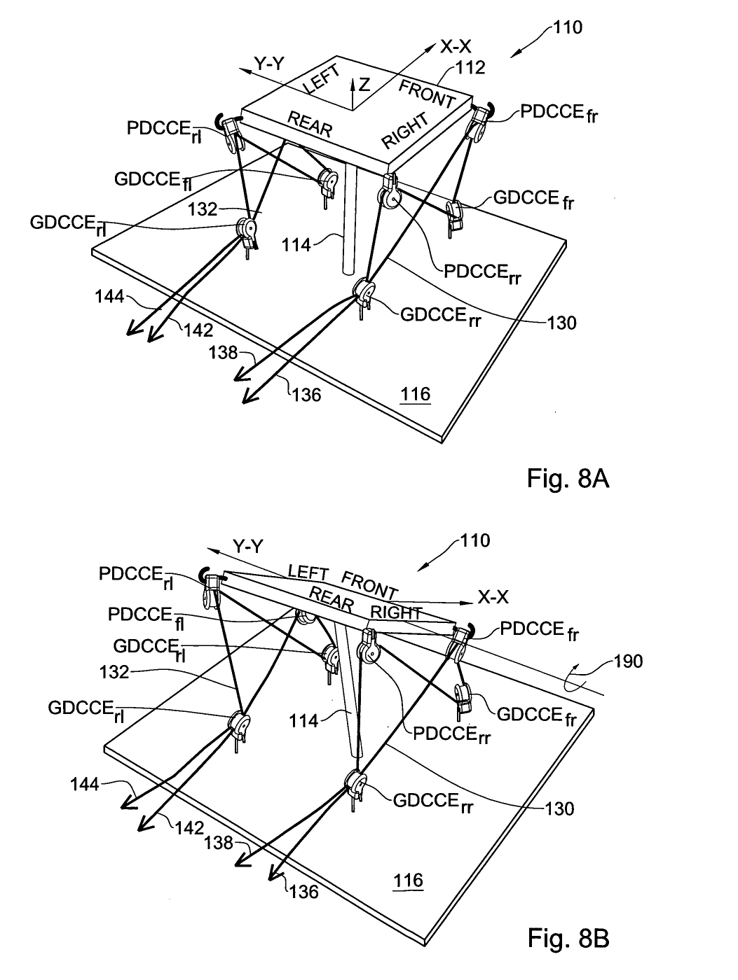

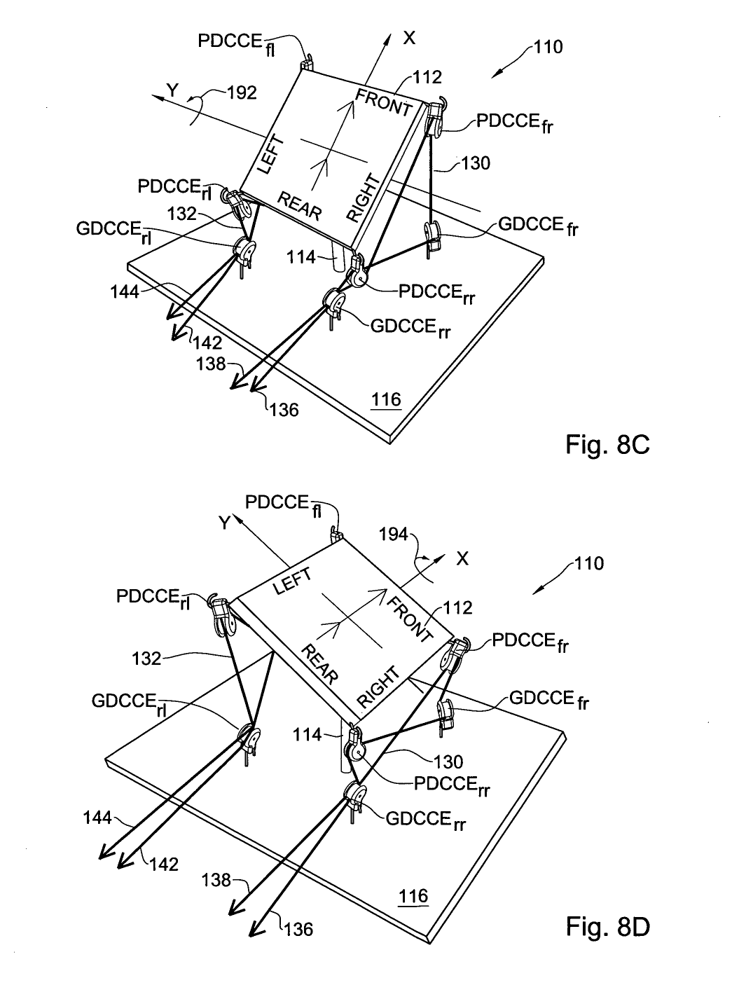

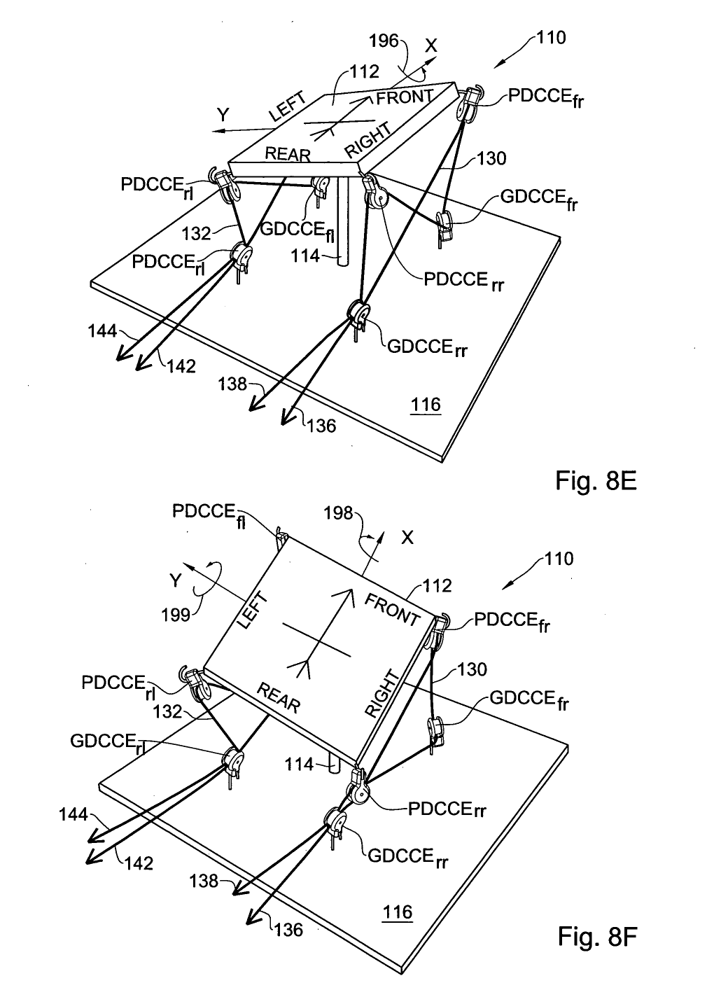

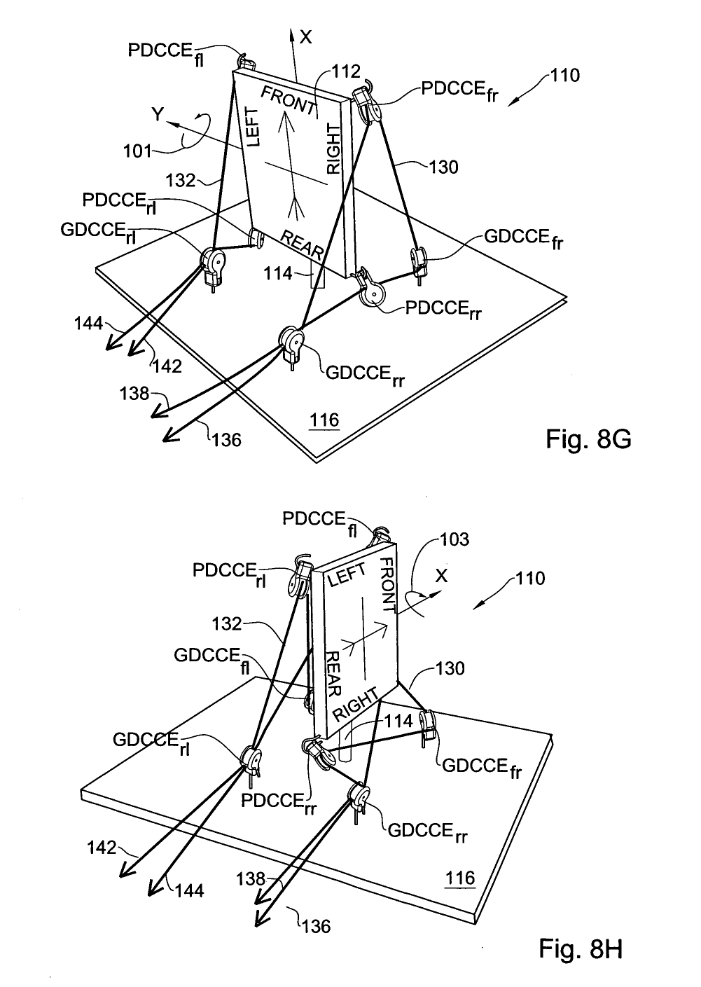

With further reference to FIGS. 8A through 8H, a system in accordance with the embodiment of FIG. 4 is illustrated, in a variety of tilting positions wherein for sake of clarification the free ends of the tension cords have been assigned with arrows indicating the tensioning thereof (arrow head facing backwards) or loosening/dispensing (arrow head heading forwards). Furthermore, like reference numbers have been used to designate like elements. It is however appreciated that the cords remain tight (i.e. tensioned) at all times.

It is appreciated that the tension cords 130 and 132 maintain tension at all times for stability of the system and its accuracy. In FIG. 5A the utility platform 112 is illustrated at a substantially horizontal position (namely the X-Y plane is substantially parallel to the support surface 116). This is the so-called start position wherein the four cord ends 136, 138, 142 and 144 are uniformly tensioned to maintain this position, and the utility platform 112 is leveled.

Obtaining the position of the utility platform as illustrated in FIG. 8B is acquired by dispensing cord ends 136 and 144 whilst simultaneously tensioning cord ends 138 and 142 whereby the utility platform 112 will pitch over the Y axis as illustrated by arrow 190.

Acquiring the position illustrated in FIG. 8c namely wherein the utility platform 112 is tilted backwards (pitching over the Y axis in direction of arrow 192) takes place by tensioning cord ends 136 and 148 whilst simultaneously dispensing cord ends 138 and 144 to the desired extent.

In FIG. 8D the utility platform 112 is tilted to the right (namely as rolled over the X axis in direction of arrow 194). This position is acquired by tensioning free ends 136 and 138 whilst simultaneous dispensing free ends 142 and 144.

The position of FIG. 8E illustrates the utility platform 112 rolling over the X axis in direction of arrow 196 in an opposite sense to that disclosed in connection with FIG. 8D. This position is acquired by tensioning free ends 142 and 144 whilst simultaneously dispensing free ends 136 and 138.

In FIG. 8F the utility platform 112 is pivoted such that its rear right corner is tilted downwards in a combined roll and pitch motion in direction of arrows 198 and 199. This position is acquired by tensioning free end 136 whilst simultaneously dispensing free ends 138, 142 and 144.

FIGS. 8G and 8H illustrate extreme positions when the utility platform 112 extends at approximately 90° with respect to the support surface 116. In FIG. 8G the utility platform 112 is tilted about the Y axis in direction of pitch arrow 101. This position is acquired by tensioning free ends 136 and 144 and simultaneous dispensing of free ends 138 and 144.

The position of FIG. 8H illustrates the utility platform 112 rolled over the X axis in direction of arrow 103such that it extends substantially vertically (perpendicular to the support surface 116). This position is acquired by tensioning free cord ends 136 and 138 and simultaneous dispensing of the free ends 142 and 144.

Whilst several significant positions have been illustrated and exemplified, it is appreciated that angular/tilt position beyond 90° degrees of the utility platform 112 is possible by appropriate manipulation of the tension cords. However, for that purpose an appropriate pivot joint is required between the top of the support post and the utility platform, e.g. as illustrated in FIG. 7. It is further appreciated that the utility platform is substantially prevented form yaw namely rotation about the vertical axis Z as long as the cords are sufficiently tensioned.

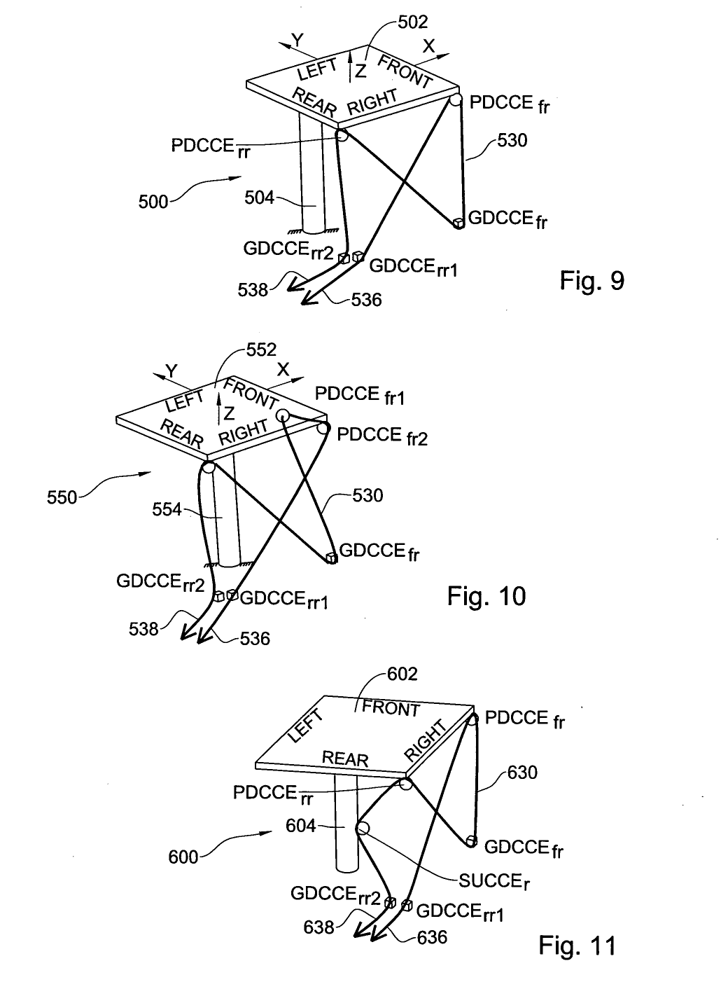

It is further appreciated that the platform cord connecting elements PCCEs may be fitted at other locations about the utility platform in a substantially symmetrically disposed manner, for example, the platform cord connecting elements PCCEs may be fitted at the middle of each of the respective edges of the utility platform, however, in this case, the entire platform will be angularly shifted by 45° (about the vertical Z axis). Turning now to FIG. 9 there is a schematic representation of a system in accordance with a modification of the present invention generally designated 500comprising a utility platform 502 mounted over a support post 504 as discussed hereinbefore. Only the rear side cord system is illustrated, for sake of simplicity. However, this particular embodiment differs from the previous embodiments in that rather than a single, rear ground cord connector element, there are provided a pair of such rear ground cord connector elements namely GDCCEᵣᵣ₁ and GDCCEᵣᵣ₂, wherein GDCCEᵣᵣ₁ serves for directing the first free end 536 and the cord connecting element GDCCEᵣᵣ₂ serves for directing the second end 538 of tension cord 530. However, and as already mentioned hereinabove, rather than two separate CCes GDCCEᵣᵣ₁ and GDCCEᵣᵣ₂ there may be provided a uniform (i.e. common) ground cord connection element, however fitted with a pair of individually rotatable pulley wheels.

Turning now to FIG. 10 there is illustrated yet another modification of the present invention generally designated 550 comprising a utility platform 552 mounted on a support post 554 as in connection with the previous embodiments. Again, only the rear side cord system is illustrated, for sake of simplicity. However, unlike the previous embodiments, the utility platform 552 has two front right platform cord connecting elements CCEs namely PDCCE_{fr1} and PDCCE_{fr2}, and two rear ground CCEs—GDCCEᵣᵣ₁ and GDCCEᵣᵣ₂ as discussed in connection with FIG. 9 The arrangement disclosed in connection with FIG. 10 as far as the pair of front platform cord connection elements allows for improved support of the utility platform.

Turning now to FIG. 11 of the drawings there is illustrated still a modification of the present invention generally designated 600 where again, only the rear side cord system is illustrated, for sake of simplicity. In this example, the utility platform 602extends over a support post 604 as disclosed in connection with previous embodiments. In this example too there is provided a pair of ground rear cord connecting elements CCEs namely GDCCEᵣᵣ₁ and GDCCEᵣᵣ₂ and further there is provided a right post cord connection element SUCCEᵣ such that the cord 630 extends from the rear right platform cord connecting element PDCCEᵣᵣ towards the right post pulley SUCCEᵣ and then through rear right ground cord connecting element GDCCEᵣᵣ₂ towards the respective motor (not shown).

It is appreciated that in the examples disclosed in connection with the previous embodiments, the front ground cord connecting elements GCCE_{fr} (two as in of FIGS. 4 and 5; one as in FIG. 6, is a cord connecting element e.g. a pulley facilitating rolling of the respective cord therethrough, whereby the utility platform is tiltable both in pitch and roll directions, as exemplified and explained.

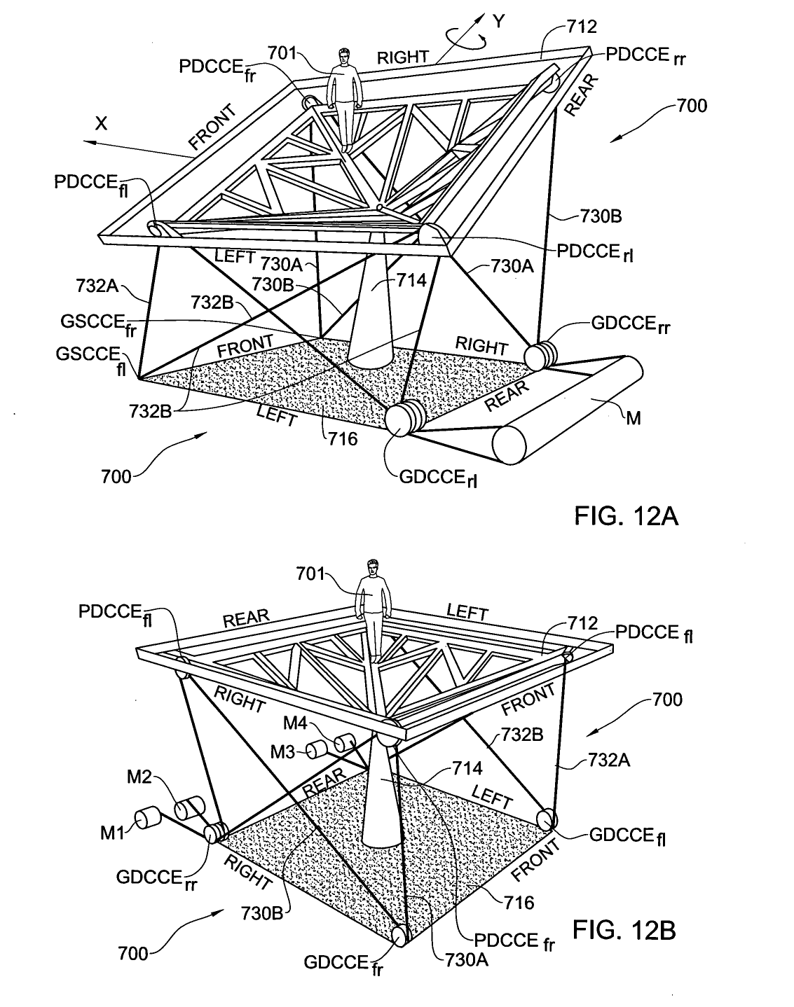

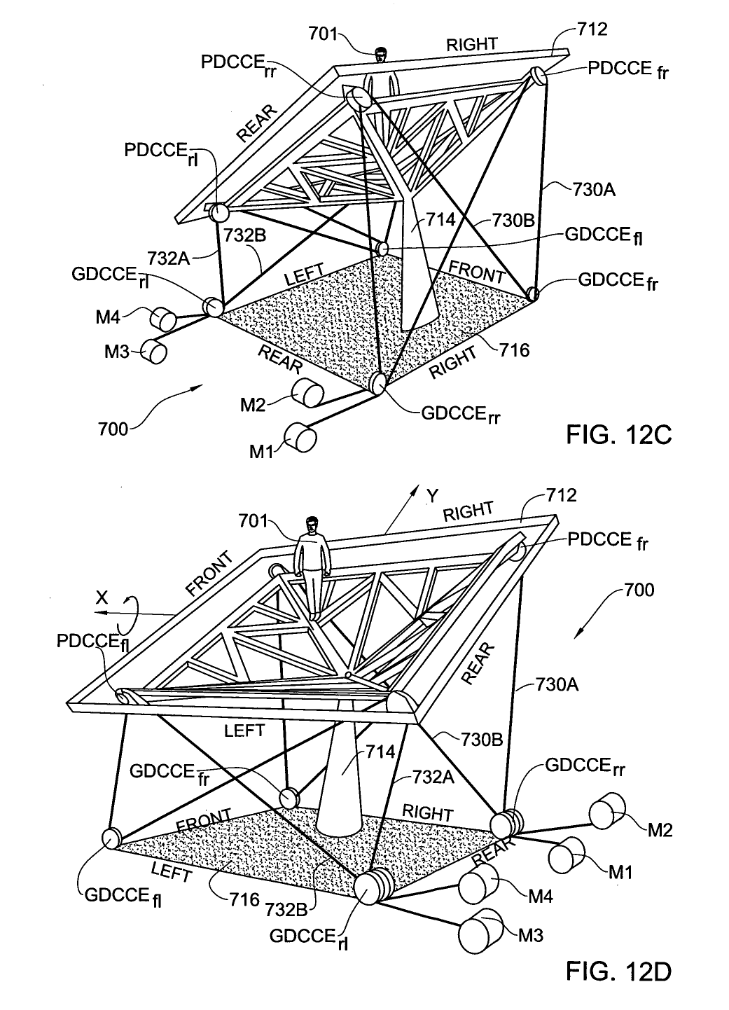

Further embodiments are illustrated with reference to FIGS. 12A and 12B.

In the embodiment of FIG. 12A there is illustrated a system which is a modification of the previous embodiments, said system generally designated 700and designed, in a particular example, to serve as a simulator device e.g. for simulating motion of a vehicle, or the like, wherein an individual 701 is positioned over the utility platform 712.

It is noticed that the utility platform 712is mounted over a single support post 714. However, this embodiment differs from previous embodiments in that the front ground cord connecting elements are static (GSCCEs) namely front left ground cord connecting element GSCCE_{fr} and front right ground cord connecting element GSCCE_{fl} fixedly secure the respective cord portions 730 and 732 to the ground surface 716(at locations extending below the front left platform cord connecting element PDCCE_{fl} and front right platform cord connecting element PDCCE_{fr}.

According to this configuration, each of the cords 730and 732 is split into a first cord segment 730A; 732B, and a second cord segment 730A; 732B. Cord segment 730A is fixed to the front right ground cord connecting element GSCCE_{fr}, and from there it extends towards the front right platform cord connecting element PDCCE_{fr} and then down towards the rear right ground cord connecting element GDCCEᵣᵣ and towards a manipulator M. The second cord segment 730B is also fixed to the front right ground cord connecting element GSCCE_{fr}, and from there it extends towards the rear right platform cord connecting element PDCCEᵣᵣ and down towards the rear right ground cord connecting element GDCCEᵣᵣ and towards a manipulator M.

Likewise, Cord segment 532A is fixed to the front left ground cord connecting element GSCCE_{fl}, and from there it extends towards the front left platform cord connecting element PDCCE_{fl} and then down towards the rear left ground cord connecting element GDCCEᵣ₁ and towards the manipulator M. The second cord segment 532B is also fixed to the front left ground cord connecting element GSCCE_{fl}, and from there it extends towards the rear left platform cord connecting element PDCCEᵣₗ and down towards the rear left ground cord connecting element GDCCEᵣₗ and towards a manipulator (motor) M.

The arrangement is such that the four platform cord connecting element s namely PDCCE_{fr}, PDCEEᵣᵣ, PDCCE_{fr} and PDCC_{fl}, and the two rear ground cord connecting elements namely GDCCEᵣᵢ and GDCCEᵣᵣ are cord connecting elements (pulleys) of the type disclosed hereinbefore facilitating rolling of the respective cords therethrough, said cords 730 and 732eventually extending to a cord tensioning motor M. The arrangement is such that tensioning the cords by means of motor M yields corresponding tilting of the utility platform 712 about the X and Y axes, namely in roll and pitch directions.

It is noted that in the embodiment of FIG. 12A a single manipulator (motor) M is used. However, as already discussed hereinabove, other configurations are possible too.

For example, FIGS. 12B to 12D are directed to a system similar to a great extent with that illustrated in FIG. 9A, however with the exception that each of the distinct cord segments 730A, 730B, 732A and 732B is coupled to an independent motor M1, M2, M3 and M4, respectively.

FIG. 12B illustrates the system 700 where the utility platform 712 is substantially horizontal, FIGS. 12C and 12D illustrate the system 700 where the utility platform 712 is tilted about the X axis (roll), this position acquired by loosening cord segments 730A and 730B by manipulating motors M1 and M2 and simultaneous tensioning cord segments 730A and 730B by manipulating motors M3 and M4.

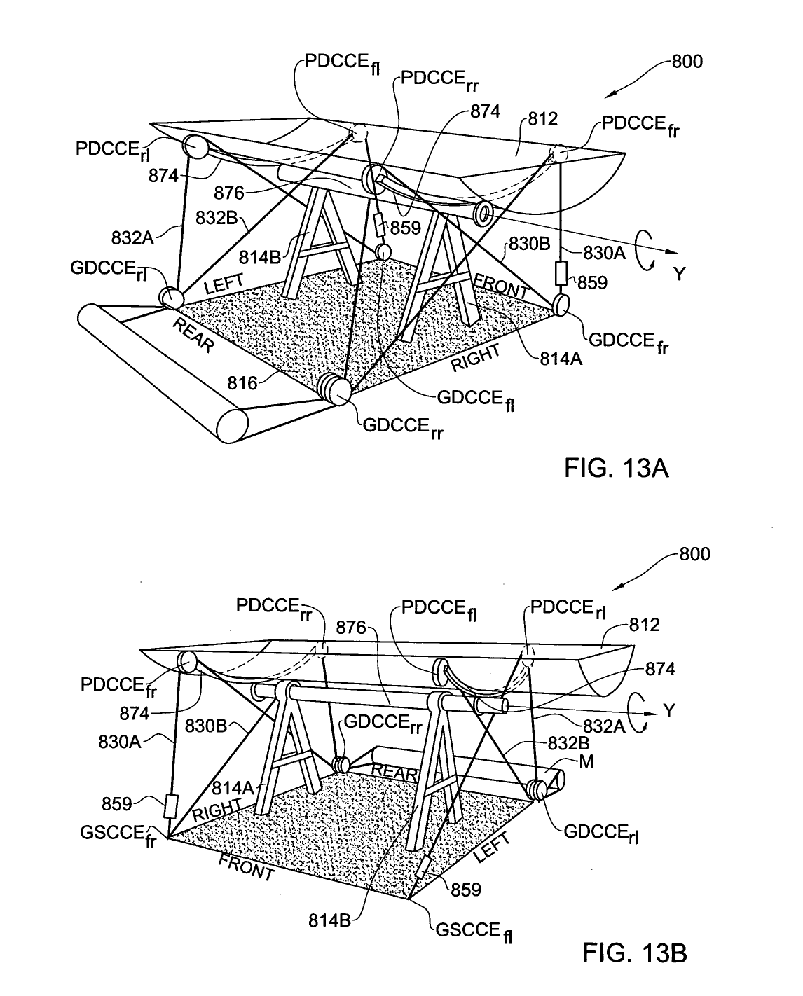

With further reference to FIGS. 13A and 13B there is illustrated a modification of the invention wherein the utility support is in the form of a trough-like collector 812 mounted on a pair of arced support arms 814 which in turn are secured to a roll axel 876 supported over a pair of support posts 814A and 814B anchored to the ground surface 816.

In the embodiment of FIGS. 13A and 13B the support arms 874 (to which the trough-like collector 812 is rigidly secured) are fitted with four respective platform cord connecting elements (pulleys) namely front left platform cord connector PDCCE_{fl}, front right platform cord connector PDCCE_{fr}, rear right platform cord connector PDCCEᵣᵣ and rear left platform cord connector PDCCEᵣᵣ. Extending below the platform cord connector elements (CCEs) there are two rear ground CCEs (i.e. pulleys) namely rear right ground cord connector GDCCEᵣᵣ and rear left ground cord connector GDCCEᵣᵣ, and two front ground anchors (SCCEs) namely front left ground static cord connecting element GSCCE_{fl} and front right ground static cord connecting element DSCCE_{fr}. Like in the previous embodiment the four platform pulleys and two rear ground pulleys facilitate rolling of respective cord portions therethrough, whilst the two front ground anchors fixedly arrest the respective cord portions secured thereto.

The arrangement in accordance with the embodiment of FIGS. 13A and 13B is such that the utility platform, namely trough-like collector 812 is tiltable only about the Y axis namely may perform only roll motion, responsive to tensioning/loosening of the cords 830 and 832, respectively.

It is appreciated that the examples of FIGS. 13A and 13B slightly differ from one another in that the system illustrated in FIG. 13A is fitted with front ground cord connection element, i.e. front right ground CCE GDCCE_{fr} and front left ground CCE GDCCE_{fl} (with a uniform cord 830 and 832, respectively, extending therethrough), whilst the system of FIG. 13B is fitted with front ground static CCE, i.e. front right ground CCE GSCCE_{fr} and front left ground CCE GSCCE_{fl} (with a segmented cord 830A; 830B and 832A; 832B, respectively, extending therethrough).

In order to maintain tension of the cords, a cord tensioning mechanism 859 is introduced on each of the cords 830 and 832, adjacent the front left ground static cord connecting element GSCCE_{fl} and the front right ground static cord connecting element GSCCE_{fr}, respectively (or at other locations along the cords). Such a tensioning mechanism may be, for example, a mechanical spring, a pneumatic spring, magnetic spring, etc.

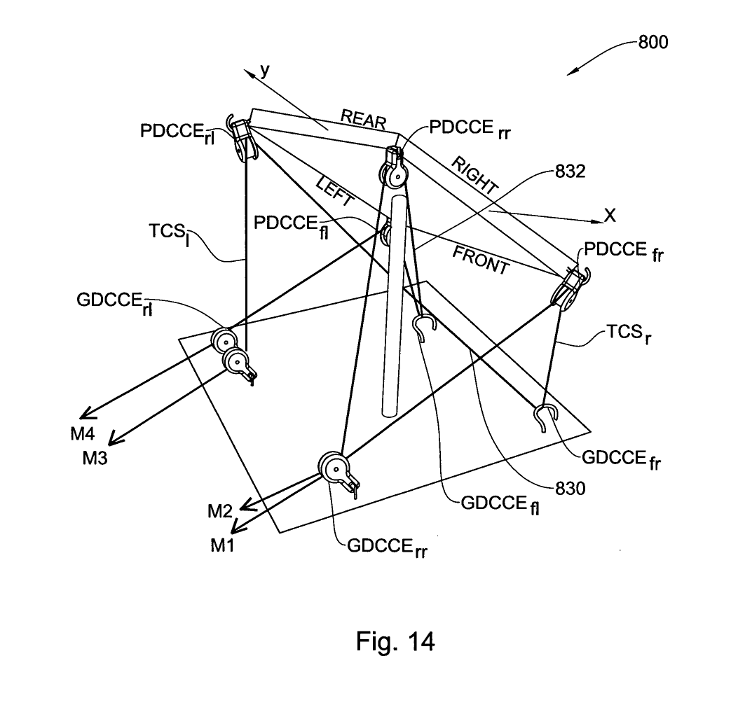

In the example illustrated in FIG. 14 there is illustrated a system generally designated 800, following the principals as discussed hereinabove, namely comprising a right tension cord system TCSᵣ and a left tension cord system TCSₗ, said TCSs extending substantially parallel to one another along the respective right and left edges of the system. However, from the right tension cord system TCSᵣ there is a cord segment 830 diagonally extending from the front right dynamic ground cord connection element (GDCCEfr) towards the rear left dynamic platform cord connection element (PDCCEᵣₗ). Likewise, from the left tension cord system TCSₗ there is a cord segment 832 diagonally extending from the front left dynamic ground cord connection element (GDCCEfl) towards the rear right dynamic platform cord connection element (PDCCEᵣᵣ). Other components are similar to those disclosed in connection with previous examples and operation thereof is substantially similar.

Those skilled in the art to which this invention pertains will readily appreciate that numerous changes, variations, and modifications can be made without departing from the scope of the invention, Mutatis Mutandis.

1. A structural support and tracking system comprising a utility platform defining an X-Y plane and supported over a central support post defining a longitudinal axis Z being normal to the plane X-Y; said utility platform comprises at least three platform cord connection elements (PCCEs); at least three left ground cord connection elements (GCCEs) associated with two left platform cord connection elements (PCCEₗ), and at least one right ground cord connection element (GCCE_{f}) associated with at least one right platform cord connection element (PCCE); a tension cord system (TCS) wherein a cord extends from each platform cord connection element (PCCE) towards at least one corresponding ground cord connection elements (GCCEs); and a manipulating system for tilting the utility platform by tension adjustment of the cords.

2. A system according to claim 1, comprising three pairs of TCSs, wherein a right TCS has a centrally positioned cord connection element, with one of the following modules of operation is selected:
(a) a right platform CCE and both corresponding ground CCEs are dynamic;
(b) a right platform CCE and one of the corresponding ground GCCEs is dynamic and the other ground GCCE is static;
(c) a right platform CCE is static and both corresponding ground GCCEs are dynamic;
(d) one ground GCCE of the two left cord tension cord systems is static (GSCCE)

3. A system according to claim 1, comprising two right ground pulleys each extending below said utility platform such that at a horizontal position of the X-Y plane the two right ground pulleys extend below corresponding two right platform pulleys, respectively.

4. A system according to claim 1, wherein four platform pulleys and four ground pulleys extend on the circumcircle of said utility platform.

5. A system according to claim 1, wherein four platform pulleys extend beyond the circumcircle of the utility platform.

6. A system according to claim 1, wherein at least two pairs of tension cord systems are parallel to one another, either at substantially the same plane or at parallel planes disposed at opposite sides of the utility platform.

7. A system according to claim 1, wherein at least one end of the cord extends to a manipulating system.

8. A system according to claim 1, wherein the support post is axially extendible/retractable.

9. A system according to claim 1, further comprising a computerized controller adapted for receiving an input signal correlative to a required pitch/roll tilt of the utility platform, said controller emitting a control signal to a manipulating system, responsive to said input signal, for respective tensioning/dispensing the cords.

10. A system according to claim 1, wherein the platform cord connection elements extend on an angle bisector between the X-X axis and the Y-Y axis.

11. A system according to claim 1, wherein the manipulating system is fitted with a cord tensioning mechanism.

12. A system according to claim 1, wherein one or more brake mechanisms are associated with each cord, to arrest the cords and prevent unintentional displacement through the cord connection elements.

13. A system according to claim 1, wherein the cord is split into a first cord segment and a second cord segment, both said segments fixedly extending from the ground CCE, up towards one of the right platform CCE and left platform CCE respectively, and down towards the ground rear cord connection element.

14. A system according to claim 2, wherein a right TCS comprise a platform CCE and a ground CCE, one of which being static and the other of which being dynamic.

15. A system according to claim 1, wherein the manipulating system comprises at least two motors whereby each cord end is independently tensioned or extended therefrom.

16. A system according to claim 1, wherein said utility platform comprises at least four platform cord connection elements (PCCEs) extending on the circumcircle of said utility platform and being equiangularly disposed thereabout; two rear ground cord connection elements (GCCEs) disposed below said utility platform such that at a horizontal position of the X-Y plane said rear GCCEs extend below rear PCCEs, respectively, and at least one front ground fixed CCE (GSCCE) extends on a radius of at least an inscribed circle but not more than the radius of circumcircle of said utility platform; a tension cord system (TCS) wherein a cord extends from each platform CCE towards a rear ground CCE at an X-Z plane, and a cord extending from each platform CCE towards said at least one front ground GCCE; and a manipulating system for at least roll tilting of the utility platform by tension adjustment of four cords extending from the two rear GCCEs.

17. A system according to claim 1, wherein where two tension cord systems extend substantially parallel to one another along right and left edges of the system respectively, at least one cord segment of one or both said tension cord systems diagonally extends towards the other of said tension cord system.
